(19) United States
(12) Patent Application Publication
(10) Pub. No.: US 2008/0003887 A1
(43) Pub. Date: Jan. 3, 2008

(54) Angled plug

(75) Inventors: Bernhard Agthe, Munchen (DE); Gero Base, Munchen (DE); Norbert Oertel, Landshut (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/823,071

(22) Filed: Jun. 26, 2007

(30) Foreign Application Priority Data
Jun. 29, 2006 (DE) 10 2006 029 927.2

(51) Int. Cl. H01R 13/04

(52) U.S. Cl. 439/694

(57) ABSTRACT

Angled plug having a device which converts a pull applied to a power cable connected to the angled plug in such a way that it causes the angled plug to be forced out of a socket. A clean copy of the Abstract that incorporates the above amendments is provided herewith on a separate page.

### CROSS REFERENCE TO RELATED APPLICATIONS

This application claims priority of German application No. 10 2006 029 927.2 filed Jun. 29, 2006, which is incorporated by reference herein in its entirety.

### FIELD OF INVENTION

The invention relates to an angled plug.

### BACKGROUND OF INVENTION

AC power plugs such as angled plugs are used in the home and in many industrial applications.

Power plugs are often pulled out of the socket by the cable, possibly damaging both the cable and the plug. Angled plugs generally have an anti-kink sleeve to protect the cable from bending. However, a high pulling force applied to the cable may nevertheless result in the cable being broken off before the anti-kink sleeve, or even in the anti-kink sleeve being strained, causing the cable to break in the region of the anti-kink sleeve.

In addition to interrupting the power supply for a device connected to the power plug, and necessitating a repair, cable breakage also poses a hazard to people due to the open live wires.

### SUMMARY OF INVENTION

An object of the invention is to specify an angled plug which offers increased safety and reliability when pulling force is applied to a connected power cable.

This object is achieved by an angled plug as claimed in an independent claim.

The angled plug has a device which converts a pull applied to a power cable connected to the angled plug in such a way as to cause the angled plug to be forced out of a socket.

The angled plug can be a plug of any national or international standard, such as a connector known as a non-heating appliance socket and which is used, for example, to supply computers with power.

The angled plug has at least two contact pins which are used to establish electrical contact, e.g. in a socket outlet. Alternatively the angled plug has at least two contact rings which are used to receive contact pins of a plug-in apparatus. An example of this alternative is a so-called non-heating appliance plug which is used, for example, for PCs. The contact pins or contact rings are parallel and define by their respective axes a plane which will hereinafter be referred to as the contact pin plane, irrespective of whether it is formed by the contact rings or contact pins.

The plug-in apparatus for the angled plug will hereinafter be referred to as a socket, the term socket also being intended to include the plug-in apparatus which is generally located on the power supply of a PC, i.e. a non-heating appliance plug.

The anti-kink sleeve, i.e. the start of the power cable connected to the angled plug outside a housing of the angled plug, does not leave the housing in a straight line running contrary to the insertion direction of the angled plug, i.e. the direction of the contact pins of the angled plug, for example. Positively formulated, this means that the anti-kink sleeve makes an angle, e.g. 90°, with the insertion direction of the angled plug. Angles other than 90° are also possible.

Depending on the pulling direction, a pulling force applied to the power cable of the angled plug causes the angled plug to be withdrawn from the socket. Due to the fact that the power cable does not leave the housing of the angled plug in a straight line, the pull applied to the power cable tends to result in the angled plug being jammed in the socket, preventing it from being successfully pulled out of the socket by the power cable.

According to the invention, the pull applied to the power cable via the device additionally causes the angled plug to be forced out of the socket, thereby advantageously preventing the cable from being broken off and therefore preventing the angled plug from being damaged. The safety of the angled plug is therefore increased.

In an advantageous embodiment of the invention, the device is implemented as a lever. The lever is embodied such that when the power cable is pulled a force is generated which assists withdrawal of the angled plug. The lever is of angled design. Alternatively the lever can be of bent design.

It is expedient here to dispose a bearing axle, about which the lever is rotatable, in the housing of the angled plug in the region of the contact pin plane. It is further advantageous to dispose the bearing axle close to an end face of the angled plug on the opposite side from the socket.

It is also expedient to dispose the bearing axle centrally with respect to the housing in the area between the axes of the contact pins or contact rings, in the region of the contact pin plane close to the angled plug's end face on the opposite side from the socket.

This arrangement ensures that conversion of the pull takes place in such a way that the angled plug does not jam, or jams as little as possible, on being withdrawn.

Alternatively it is possible for the device to be implemented as a pair of levers, it being advisable to dispose the levers of the lever pair symmetrically in such a way that the plane of symmetry which would project one lever onto the other corresponds to the plane of symmetry which—in the case of two contact pins—would project one contact pin onto the other. That can mean, for example, that the bearing axle of one of the levers is disposed in the contact pin plane on the right-hand side of a right-hand contact pin close to the angled plug's end face on the opposite side from the socket. Correspondingly, in this example the bearing axle of the other lever is disposed in the contact pin plane on the left-hand side of a left-hand contact pin close to the angled plug's end face on the opposite side from the socket. Alternatively it is also possible to dispose the levers asymmetrically.

Advantageously the lever is embodied in such a way that a first, essentially straight lever arm extends from the bearing axle of the lever into the anti-kink sleeve, while a second, angular lever arm essentially extends as far as the plug head end face in the insertion direction. The plug head end face is defined as the surface of the angled plug from which the contact pins protrude or through which the contact rings extend into the housing.

It is advantageous in this case if the second, angular lever aim essentially ends at the plug head end face, which means that the angled plug essentially has the external shape of angled plugs known from the prior art, but that even a small force applied to the power cable, i.e. a slight pull, causes the angled plug to be forced out of the socket.

In an advantageous embodiment of the invention, the second, angular lever arm is rounded off where it ends at the plug bead end face, thereby preventing mechanical abrasion or destruction of the socket and of the lever arm of the angled plug when the latter is forced out by the device.

In a further advantageous embodiment of the invention, the second, angular lever arm has a wheel where it ends at the plug head end face.

This advantageously means that better conversion of the force acting on the anti-kink sleeve to force the angled plug out of the socket is achieved, as the wheel minimizes the friction of the end of the second, angular lever arm on the socket.

The angled plug is preferably implemented as a grounded Schuko-type plug.

### BRIEF DESCRIPTION OF THE DRAWINGS

Further details and advantages of the invention will be explained with reference to the accompanying drawings, in which:

FIG. 1 shows an angled plug with a lever in the straight position

FIG. 2 shows an angled plug with a lever in the rotated position

FIG. 3 shows an angled plug with a lever in another view

FIG. 4 shows an angled non-heating appliance socket

### DETAILED DESCRIPTION OF INVENTION

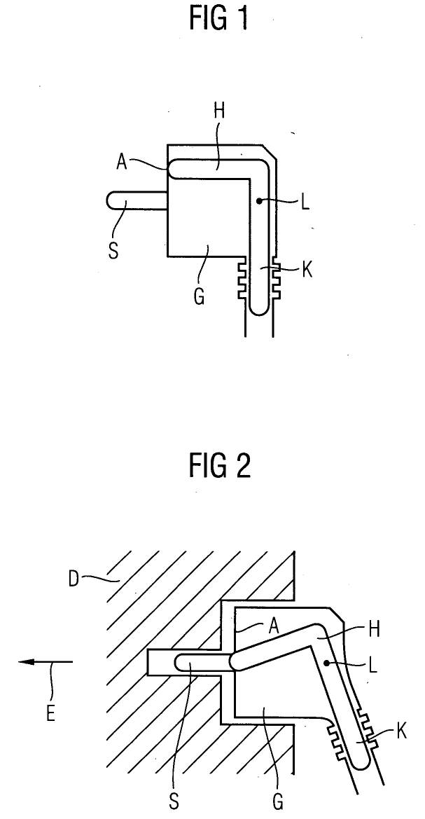

FIG. 1 shows a typical “type F” angled plug. The angled plug has contact pins S which protrude from a plug housing G. The angled plug additionally has an anti-kink sleeve K which emerges from the opposite side of the plug housing G to the contact pins, at right angles to the direction of the contact pins. The angled plug has a lever H which runs from the anti-kink sleeve K via the bearing axle L to the plug head end face A. The insertion direction E runs parallel to the contact pins S in the direction of the socket D. The bearing axle L is preferably rigidly connected to the plug housing G.

The bearing axle L around which the lever H is pivotally mounted is disposed in the plane of the contact pins S in the plug housing C close to the opposite side of the plug housing C to the contact pins. The lever H can be caused to rotate by the anti-kink sleeve K being pulled in the opposite direction to the insertion direction E of the angled plug. If such a force is exerted, the lever H rotates about the bearing axle L. The result of such a rotation is sketched in FIG. 2.

FIG. 2 shows the same angled plug with the lever H which is now rotated by a force acting on the anti-kink sleeve K. FIG. 2 also schematically illustrates a socket D. The end of the lever H at the plug head end face A now protrudes from the plug head end face A, causing the angled plug to be forced out of the socket D.

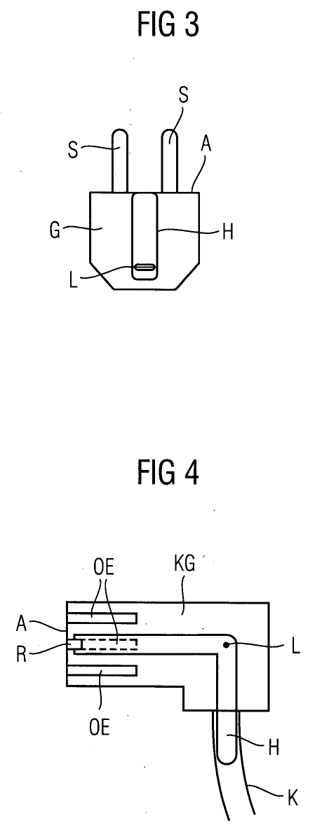

FIG. 3 is another view of the angled plug from FIGS. 1 and 2, showing that the bearing axle is disposed centrally between the contact pins S, close to the angled plug's end face on the opposite side from the socket.

FIG. 4 shows an angled non-heating appliance socket KG (normally termed a non-heating appliance plug) with three contact rings OE. This non-heating appliance socket KG is used for connecting e.g. PCs. The non-heating appliance socket KG again contains an angular lever H extending from the anti-kink sleeve of the power cable to the bearing axle L and from there to the plug head end face A. The bearing axle is here again disposed centrally between the two contact rings OE, close to the angled plug's end face on the opposite side from the socket.

In the embodiment of the inventive angled plug shown in FIG. 4 the end of the lever H is provided with a small wheel R at the plug head end face A. This wheel R forms the outer end of the lever H. As rotation of the lever H causes the end of the lever H to move in at least two directions at the plug head end surface, friction occurs between the end of the lever and the socket. This friction is reduced by the wheel R, since the wheel R can roll along the inside of the socket.

1.-8. (canceled)

9. An angled plug, comprising:
a device to convert a pull applied to a power cable connected to the angled plug into a force to cause the angled plug to be forced out of a socket.

10. The angled plug as claimed in claim 9, wherein the device is a lever.

11. The angled plug as claimed in claim 10, wherein the device is a pair of levers.

12. The angled plug as claimed in claim 10, wherein the lever has a bearing axle, and wherein the bearing axle is disposed in the plug head in a plane formed by contact pins of the angled plug.

13. The angled plug as claimed in claim 10, wherein the lever has a first essentially straight lever arm and a second angular lever arm, wherein the first essentially straight lever arm extends from a bearing axle of the lever into an anti-kink sleeve of the angled plug, and wherein the second lever arm essentially leads to a plug head end face.

14. The angled plug as claimed in claim 13, wherein the plug head end face is a face of the plug from which contact pins protrude.

15. The angled plug as claimed in claim 14, wherein the second, angular lever arm essentially ends at the plug head end face.

16. The angled plug as claimed in claim 14, wherein the second angular lever arm is rounded off where it ends at the plug head end face.

17. The angled plug as claimed in claim 14, wherein the second angular lever arm has a wheel at a ending at the plug head end face.

18. The angled plug as claimed in claim 9, wherein the angled plug has a ground connector.
